(19) United States
(12) Patent Application Publication
(10) Pub. No.: US 2021/0116284 A1
(43) Pub. Date: Apr. 22, 2021

(54) ASSEMBLY WITH A UTILITY METER AND AN AUTONOMOUS SENSOR, AND METHOD FOR OPERATING THE ASSEMBLY

(71) Applicant: Diehl Metering Systems GmbH, Nuemberg (DE)

(72) Inventors: Roland Gottschalk, Schwabach (DE); Klaus Gottschalk, Winkelhaid (DE)

(21) Appl. No.: 17/136,130

(22) Filed: Dec. 29, 2020

Related U.S. Application Data
(63) Continuation of application No. PCT/EP2019/065808, filed on Jun. 17, 2019.

(30) Foreign Application Priority Data
Jul. 7, 2018 (DE) 102018005414.5

(51) Int. Cl. G01F 15/06; H04Q 9/00

(52) U.S. Cl. CPC G01F 15/063; H04Q 2209/40; H04Q 9/00

(57) ABSTRACT

An assembly includes at least one utility meter for measuring flow rate and at least one autonomous sensor for recording measured quantities other than the flow rate. The utility meter has a measured value generator, a computing unit and a communication device. The sensor has a sensor unit, a computing unit, and a communication device. The utility meter has an interface for radiocommunication with the autonomous sensor and an interface for transmitting the data received from the autonomous sensor. In a method for operating such ab assembly the utility meter and/or the autonomous module communicate with the autonomous sensor, and the utility meter and/or the autonomous module forward the data received from the autonomous sensor.

### CROSS-REFERENCE TO RELATED APPLICATION

This application is a continuation, under 35 U.S.C. § 120, of copending international application No. PCT/EP2019/065808, filed Jun. 17, 2019, which designated the United States; this application also claims the priority, under 35 U.S.C. § 119, of German patent application No. DE 10 2018 005 414, filed Jul. 7, 2018; the prior applications are herewith incorporated by reference in their entirety.

### BACKGROUND OF THE INVENTION

### Field of the Invention

The present invention relates to an assembly comprising a utility meter and an autonomous sensor. There is provided at least one utility meter for recording flow rate, and at least one autonomous sensor for recording measured quantities other than the flow rate. The utility meter includes a measured value generator, a computing unit, and a communication device. The sensor includes a sensor unit, a computing unit, and a communication device. The present invention further relates to a utility meter and also to a method of operating the assembly.

Generic utility meters are designed in such a way that they have all the components necessary for their operation. Reading units are thus also built into the utility meters in order to be able to perform the meter reading on the utility meter. Mechanical or digital designs of the reading unit are provided for this purpose. In order to record the meter reading, in conventional utility meters the meter reading is taken by a person on each utility meter and is then noted down or manually entered into a data collection device. In the case of electronic utility meters, the facility is available in some instances for optical data transmission by way of an infrared interface. Utility meters are further known which transmit the meter reading via a radiocommunication link, for example via a mobile radio system.

Data transmission from metering units, such as e.g. sensors, utility meters or components of smart home controllers, is becoming increasingly important in everyday use. One important field of application of metering units is the use of intelligent utility meters, also known as smart meters. These are normally utility meters incorporated into a supply network, e.g. for energy, power, gas or water, which indicate actual consumption to the respective connection user and use a communication network to transmit the consumption data to the provider. Intelligent utility meters offer the advantage that manual meter readings are no longer required and shorter-term billing can be implemented by the provider according to actual consumption. Shorter-term reading intervals in turn enable a more accurate linkage between end customer tariffs and the development of trading prices for electricity. The supply networks can also be substantially more effectively utilized.

Generic consumption data collection devices or utility meters normally transmit the accrued metering data in the form of data packets or data messages via a radiocommunication link, for example in the SRD (Short Range Devices) or ISM (Industrial, Scientific, Medical) frequency range to higher-level data collectors, (e.g. concentrators, network node points or central control rooms of a provider). Data messages are normally made up of a plurality of data packets. The SRD or ISM frequency ranges offer the advantage that they are license-free and only a general permit from the frequency authority is required for use. However, the problem exists that interference can often occur due to the frequency of use of frequency ranges of this type for a wide range of technical devices, such as, for example, garage door controls, alarm systems, WLAN, Bluetooth, smoke detectors or the like.

Electronic consumption data collection devices with a radio transmitter for wireless data transmission are frequently used for walk-in, walk-by, drive-by or fly-by reading. For this purpose, the metering devices are read by means of a mobile radio receiver by customer service personnel from a vehicle (drive-by) or on foot (walk-by) without having to enter the building to be read. In the case of intelligent utility meters, energy consumption, on the one hand, since these meters are mainly battery-controlled and are intended to have the longest possible maintenance intervals, and operational reliability, on the other hand, are of decisive importance. In the above-mentioned reading methods, radio messages are frequently transmitted throughout the entire year, said messages being very short in order to save energy so that a frequent transmission over a long time period is possible.

WO 2015/192174 A1 discloses a device that connects a personal control device to an intelligent meter, and also a home automation device to a personal communication module which is configured to communicate with the personal control device via either peer-to-peer or non peer to peer communication protocols. The device further comprises a communication module in order to communicate with the intelligent meter and the home automation device.

Our earlier, commonly assigned German patent DE 10 2014 102 007 B4 describes a method for transmitting data from terminal devices by means of forwarding via data collectors to a central computing device, wherein the data collector compiles message datasets from the received data of the terminal devices or status data and transmits them to the central computing device which holds these message datasets ready for retrieval.

### BRIEF SUMMARY OF THE INVENTION

It is an object of the invention to provide an assembly with a utility meter and an autonomous sensor, as well as a method of operating the assembly, which overcome a variety of disadvantages of the heretofore-known devices and methods of this general type and which provide for a novel assembly and a novel method by way of which an improved economy and flexibility are enabled in the operation of a utility meter.

With the above and other objects in view there is provided, in accordance with the invention, an assembly, comprising:

at least one utility meter for recording a flow rate, said at least one utility meter having a measured value generator, a computing unit, and a communication device; and

at least one autonomous sensor for recording measured quantities other than the flow rate, said at least one sensor having a sensor unit, a computing unit, and a communication device;

said at least one utility meter having an interface for radio-communication with said autonomous sensor, and

said at least one utility meter having an interface for transmitting data received from said at least one autonomous sensor.

According to the invention, an assembly is provided which comprises at least one utility meter for recording flow rate, and at least one autonomous sensor for recording measured quantities other than the flow rate, wherein the utility meter comprises a measured value generator, a computing unit and a communication device, and the sensor comprises a sensor unit, a computing unit and a communication device, wherein, in a characterizing manner, the utility meter has an interface for radiocommunication with the autonomous sensor, and the utility meter has an interface for transmitting the data received from the autonomous sensor.

It is advantageously possible for the utility meter to be extendible by means of external autonomous sensors. The autonomous sensors record measured quantities which are not normally recorded by the utility meter. This further provides the facility to subsequently extend the measurement scope or functional scope of the utility meter. Autonomous sensors can thus be added to the assembly or sensors already installed can be exchanged in order to meet specific requirements. The utility meter can thus perform the function of a gateway for the autonomous sensor.

A further advantage can be found in the form factor of the sensors. The autonomous sensors can thus be dimensioned as smaller than the utility meter. A facility can thus be created for the autonomous sensors to be installed at locations where there would be too little space for a utility meter. The autonomous sensor can appropriately have its own energy supply, as a result of which it is independent from the utility meter or from a further energy source. The utility meter and/or the autonomous sensor can appropriately be designed as energy self-sufficient. It can be particularly appropriate if the energy supply of the autonomous sensor is independent from the energy supply of the utility meter.

It is particularly appropriate if the assembly comprises an external autonomous module, preferably a data collector, having a housing and a communication device. The autonomous module can, for example, perform the function of a data collector. It can thus receive, temporarily store and forward data. The autonomous module can further act as a gateway for the sensor data from the autonomous sensors. It can similarly be a gateway for data, in particular consumption data, of the utility meter.

The utility meter and/or the autonomous sensor can in each case appropriately comprise their own housing. The autonomous sensor can appropriately be present at a location separate from the utility meter so that both units in each case have their own housing. The autonomous sensor can thus be fitted at one location of a pipeline and the utility meter at a different location of the pipeline so that the utility meter is locally separated from the autonomous sensor.

The autonomous sensor can appropriately transmit data, in particular sensor data, to the utility meter and/or to the autonomous module. Insofar as data, in particular sensor data, are transmitted from the autonomous sensor to the utility meter, the utility meter can, for example, temporarily store the sensor data before they are forwarded. It is furthermore possible for a preliminary evaluation of the sensor data to take place in the utility meter. A facility can thereby be created to respond in advance to imminent outages or damage, for example to the pipeline.

The communication device of the utility meter and/or the communication device of the autonomous sensor and/or the communication device of the autonomous module can advantageously have a local communication interface which is configured to communicate via local communication paths. Insofar as the communication devices of the utility meter and/or of the autonomous sensor and/or of the autonomous module have preferably the same local communication paths, the possibility exists for data transmission between the participants. External communication modules such as external autonomous sensors or external autonomous modules can thus be easily incorporated into the assembly. This enables a simple and subsequent extendibility, and also increased flexibility in the design of the entire assembly.

It is particularly advantageous if the local communication paths are based on an Internet of Things (IoT) communication standard. The local communication paths can appropriately be based on an IoT communication standard in order to be able to easily incorporate, for example, autonomous sensors designed for energy-saving. Autonomous sensors which are designed particularly for IoT can advantageously require only a low bandwidth for communication. Sensors of this type can further have wake-up functions so that a fast response behavior from an idle state is possible. Possible IoT communication protocols are, for example, THREAD, Bluetooth Low Energy, Zigbee and Z-Wave.

It is possible for the local communication paths to be based on the IEEE 802.15.4 communication standard. The IEEE 802.15.4 standard describes a transmission protocol for Wireless Personal Area Networks (WPAN). The standard defines the lowest two layers of the OSI (Open Systems Interconnection) model, the physical layer and the MAC layer. Higher protocol levels with routing functions and an application interface are implemented through other standards for radiocommunication networks, such as, for example, ZigBee. The IEEE 802.15.4 standard is also used, for example, by 6LoWPAN (IPv6 over Low power Wireless Personal Area Network). 6LoWPAN is a communication protocol for radio data transmission which is used by THREAD. THREAD is an IPv6-based, energy-saving network technology for IoT products. THREAD is designed for mesh networking. It is furthermore IP-addressable with AES encryption. Insofar as the local communication paths are based on the IEEE 802.15.4 communication standard, this offers the advantage that a multiplicity of different radiocommunication networks can be implemented which are particularly suitable for an IoT application.

It is possible for the local communication paths to be based on the Bluetooth Low Energy (BLE) communication standard. The Bluetooth Low Energy (BLE) communication standard is a radiocommunication technology with which devices can be networked within a radius of approximately 10 meters. BLE differs from Bluetooth in terms of a significantly lower power consumption and lower costs. BLE operates in the 2.4 GHz ISM band and is furthermore suitable for IoT applications.

It is particularly appropriate if the communication device of the utility meter and/or the communication device of the autonomous module have a tertiary communication interface which is configured to communicate via tertiary communication paths with a central entity. Low Power Wide Area Networks (LPWAN) can appropriately be used for the tertiary communication paths. LPWAN describes a class of network protocols for connecting low-energy devices to a network server. Low-energy devices can be e.g. utility meters and sensors. Due to the low-energy device connection facility, LPWAN is further suitable for IoT applications. A network server can be present, for example, in the central entity. Examples of LPWAN are LoRaWAN or LoRa of the LoRa Alliance, Sigfox or Silver Spring from Silver Spring Networks. These tertiary communication paths can be configured to communicate with a central entity. The central entity may, for example, be a network operator or energy supplier.

The tertiary communication paths can appropriately have a longer radiocommunication range than the local communication paths. The utility meter is advantageously capable of transmitting and receiving data via local and also via tertiary communication paths. This offers the advantage that the utility meter can communicate not only via local communication paths with external autonomous sensors, but also over longer distances by means of tertiary communication paths with a central entity such as a network operator or energy supplier. In the same way as the utility meter, an external autonomous module is advantageously capable of transmitting and receiving data via tertiary communication paths. The utility meter and the autonomous module can thus forward sensor data from the autonomous sensor to the central entity. Communication between the utility meter and the autonomous module is further possible via the local communication paths.

If a plurality of autonomous sensors are provided, each autonomous sensor can advantageously have an individual identifier so that each autonomous sensor is individually addressable. This offers the advantage that a plurality of sensors can easily be incorporated into the assembly. Different types of sensors which forward their sensor data, for example to the utility meter, can furthermore be used simultaneously. Possible types of autonomous sensors are, for example, pressure sensors, for example for water pressure, and also quality sensors, such as e.g. sensors for water quality. The chlorine content of the water, for example, is measured to determine water quality. Sensors for detecting micro-leakages can further be used in order to detect, for example, damage to the pipeline. If a plurality of autonomous sensors are provided, it is possible, for example, for some of the sensors to transmit their sensor data to the utility meter and for other sensors to transmit the sensor data directly to an external autonomous module.

With the above and other objects in view there is also provided, in accordance with the invention, a utility meter for flow rate measurement that is specifically configured for the above-described assembly. It is thus advantageously possible to retrofit the utility meter with further external autonomous sensors which are not yet present during the installation of the utility meter.

With the above and other objects in view there is also provided, in accordance with the invention, a method for operating the above-summarized assembly. The utility meter and/or the autonomous module communicate with the autonomous sensor, and the utility meter and/or the autonomous module forward the data received from the autonomous sensor. It is thus possible for communication to take place only between the utility meter and the autonomous sensor, wherein the utility meter forwards the data received from the sensor. Alternatively or additionally, the autonomous module can, for example, communicate with the autonomous sensor and forward the data received from the sensor. The utility meter and/or the autonomous sensor can appropriately be designed as energy self-sufficient. The method advantageously imposes no additional demands in terms of the energy requirement of the utility meter or the autonomous sensor.

The utility meter can appropriately forward the data received from the autonomous sensor to a central entity and/or to an autonomous module. The utility meter can forward the data received from the autonomous sensor in different ways. The utility meter can, for example, forward the sensor data directly to the central entity and/or to an autonomous module. It is also possible for the sensor data to be e.g. temporally stored until a certain data volume is attained or until a specific time. A choice can further be made between the central entity or an autonomous module as the transmission destination of the utility meter. Insofar as data are transmitted from the utility meter to the autonomous module, said data can then be forwarded, for example, from the autonomous module to the central entity.

The sensor data can advantageously be dispatched as bundled with the consumption data. Due to the bundling, for example, the entire data consisting of consumption data and sensor data can be dispatched with a transmission at a specific time. Possible destinations of the transmission are e.g. the central entity or an autonomous module. The bundled data are, for example, easier to handle there.

Other features which are considered as characteristic for the invention are set forth in the appended claims.

Although the invention is illustrated and described herein as embodied in assembly with a utility meter and an autonomous sensor, and method for operating the assembly, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a simplified schematic view of an assembly consisting of a utility meter, an autonomous sensor and an autonomous module;

FIG. 2 is a simplified schematic view of an assembly consisting of a utility meter, a plurality of autonomous sensors and an autonomous module;

FIG. 3 is a highly simplified schematic view of an assembly consisting of a utility meter, an autonomous sensor and a central entity;

FIG. 4 is a highly simplified schematic view of an assembly consisting of a utility meter, an autonomous sensor, an autonomous module and a central entity; and

FIG. 5 is a highly simplified schematic view of an alternative assembly consisting of a utility meter, an autonomous sensor, an autonomous module and a central entity.

### DETAILED DESCRIPTION OF THE INVENTION

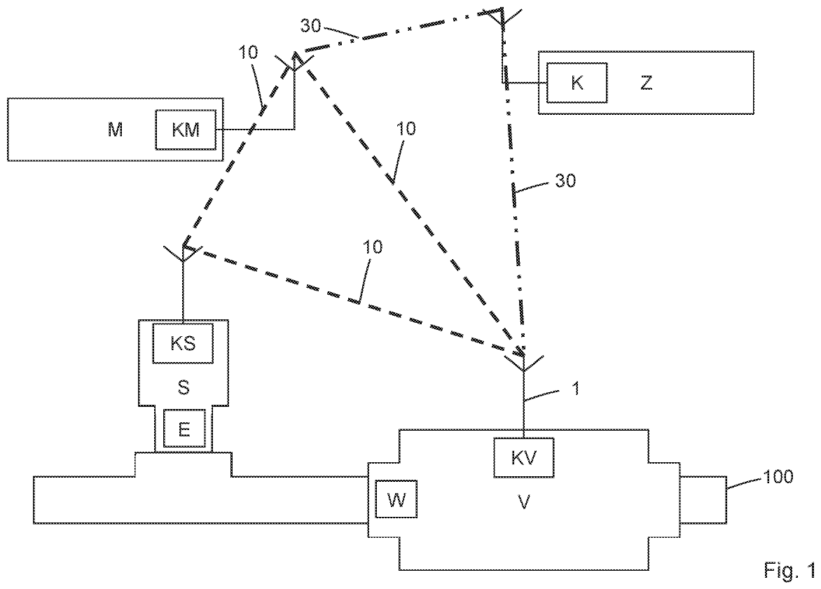

Referring now to the figures of the drawing in detail, FIG. 1 shows a simplified schematic view of an assembly consisting of a utility meter V, an autonomous sensor S and an autonomous module M. The utility meter is installed in a pipeline 100. In the present example, the pipeline 100 is a water pipe. By means of its measured value generator W, the utility meter V measures the water consumption by the pipeline 100. The utility meter V further has a communication module KV and a radio antenna 1.

An autonomous sensor S is further fitted to the pipeline 100. The autonomous sensor S is located at a certain distance from the utility meter V. The autonomous sensor S comprises a sensor unit E which detects, for example, characteristics of the water and/or of the pipeline. The sensor unit E of the autonomous sensor S can thus detect, for example, the water pressure, the water quality and micro-leakages in the pipeline 100. The chlorine content of the water, for example, can be recorded in the monitoring of the water quality. The autonomous sensor S further has a communication module KS and a radio antenna 1.

The communication module KV of the utility meter V and the communication module KS of the autonomous sensor S have local communication interfaces which are configured to communicate with one another via local communication paths 10. The communication between the autonomous sensor S and the utility meter V takes place, for example, via Bluetooth Low Energy (BLE). The utility meter V can thus read out the autonomous sensor S which is located in the immediate vicinity. It is also possible for the autonomous sensor S to transmit its data, in particular its recorded sensor data, actively to the utility meter V. The utility meter V thus acts as a gateway for the autonomous sensor S.

The assembly shown in FIG. 1 further comprises an autonomous module M. The autonomous module M has a communication module KM and a radio antenna 1. The autonomous module M or the communication module KM is further configured to communicate via local communication paths 10. Along with the utility meter V, the autonomous module M is also capable of receiving sensor data from the autonomous sensor S. The autonomous module M is thus connected via local communication paths 10 to the autonomous sensor S and to the utility meter V. The utility meter V can further transmit the consumption data recorded by means of the measured value generator W to the autonomous module M. It is thus possible for the autonomous sensor S to transmit the recorded sensor data to the utility meter V which in turn transmits these sensor data alone or together with the consumption data to the autonomous module M.

The communication device KV of the utility meter V additionally has a tertiary communication interface. This tertiary communication interface is configured to communicate via tertiary communication paths 30 with a central entity Z. For this purpose, the central entity can have a communication module K which communicates via tertiary communication paths 30. The central entity Z is, for example, the network operator or the energy supplier. The central entity can thus perform, for example, the function of a head-end system. The tertiary communication path 30 has a longer radiocommunication range than the local communication path 10. The communication between the utility meter V and the central entity Z thus takes place, for example, via a Long Range Wide Area Network (LoRaWAN). The utility meter V transmits the consumption data together with the sensor data received from the autonomous sensor S via the tertiary communication path 30 to the central entity Z.

The communication device KM of the autonomous module M similarly has a tertiary communication interface. This tertiary communication interface is similarly configured to communicate via tertiary communication paths 30 with the central entity Z. The communication between the autonomous module M and the central entity Z similarly takes place, for example, via a Long Range Wide Area Network (LoRaWAN). Alternatively, the communication between the autonomous module M and the central entity can also take place via a network protocol which differs from the network protocol with which the utility meter V communicates with the central entity Z. The utility meter V can thus, for example, communicate via a Long Range Wide Area Network (LoRaWAN) network protocol and the autonomous module M can communicate via the Sigfox network with the central entity Z. The sensor data which the autonomous module M has received from the autonomous sensor S are transmitted by the autonomous module M via the tertiary communication path 30 to the central entity Z.

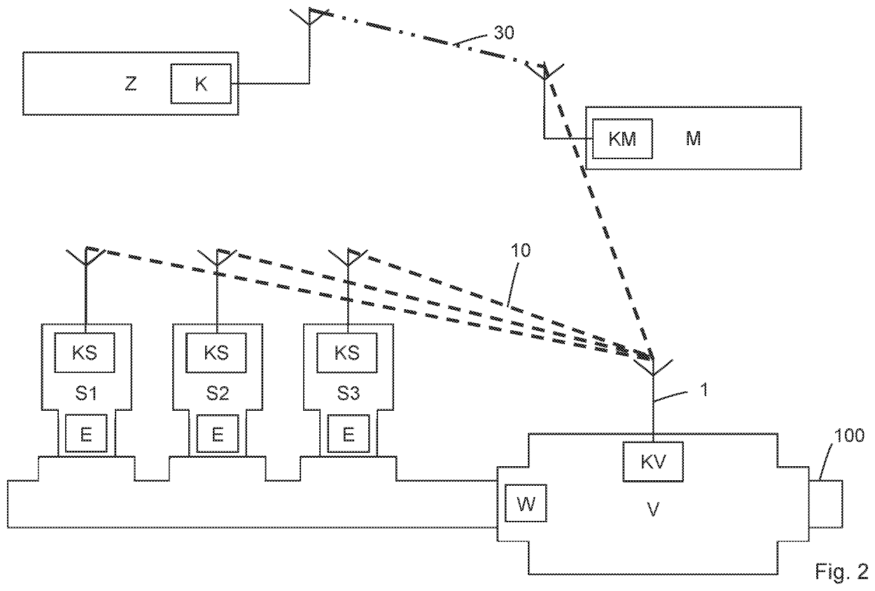

FIG. 2 shows a simplified schematic view of an assembly consisting of a utility meter V, a plurality of autonomous sensors S1-S3 and an autonomous module M. The autonomous sensors S1-S3 have been installed by the water supplier in the pipeline 100. The utility meter V is located close to the three autonomous sensors S1-S3. The respective sensor units E of the autonomous sensors S1-S3 are different or different measured values are recorded. The sensor unit E of the first autonomous sensor S1 thus measures the water pressure in the pipeline 100. The sensor unit E of the second autonomous sensor S2 measures the water quality. Micro-leakages in the pipeline 100 are detected with the sensor unit E of the third autonomous sensor S3. The water supplier pursues the aim, for example, of monitoring the chlorine content of the water by means of the sensor for the water quality. The communication devices KS of the autonomous sensors S1-S3 communicate via local communication paths 10 with the utility meter V. All communication devices KS of the autonomous sensors S1-S3 have, for example, a Bluetooth Low Energy interface. The sensors S1-S3 are connected via this interface to the utility meter V. The autonomous sensors S1-S3 transmit their data or sensor data to the utility meter V, where the data from the autonomous sensors S1-S3 are collected. The utility meter V transmits its meter reading or its consumption data and the data collected from the autonomous sensors S1-S3 together via tertiary communication paths 30 to an autonomous module M. The transmission via tertiary communication paths 30 can take place, for example, via a LoRa interface. The autonomous module M forwards the data received from the utility meter V to a central entity Z, e.g. to the water supplier. The autonomous module M can use the same LoRa interface for this transmission. As a result, the water supplier has the facility to monitor the entire system consisting of the utility meter V and the autonomous sensors S1-S3 without having to be present in situ.

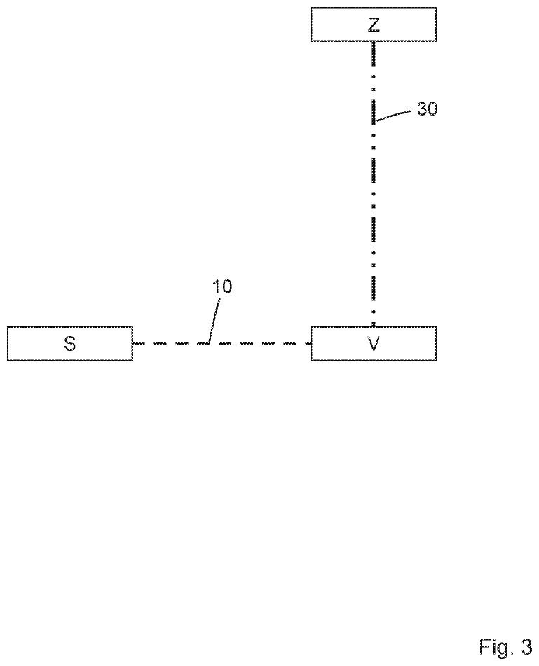

Possible designs of the assembly are shown in the following FIG. 3 to FIG. 5:

A highly simplified schematic view of an assembly consisting of a utility meter V, an autonomous sensor S and a central entity Z is shown in FIG. 3. The autonomous sensor S communicates with the utility meter V via local communication paths 10. The utility meter V and the autonomous sensor S in each case contain a local BLE/THREAD communication interface. The utility meter V communicates via tertiary communication paths 30 with the central entity Z. LoRa, Sigfox, Silver Spring or a different LPWAN communication protocol, for example, can be used as a tertiary interface. Only the utility meter V acts as a gateway here for the sensor data from the autonomous sensor S. The utility meter V can store and bundle the received data and transmit them together or separately with the consumption data to the central entity Z. The forwarding to the central entity Z can be performed cyclically at defined times or according to a defined schedule. The central entity Z may, for example, be the network operator and/or the energy supplier for whom it is possible, by means of the additional sensor data, for example to detect leakages, to check the pressure in the pipeline 100 or monitor the water quality.

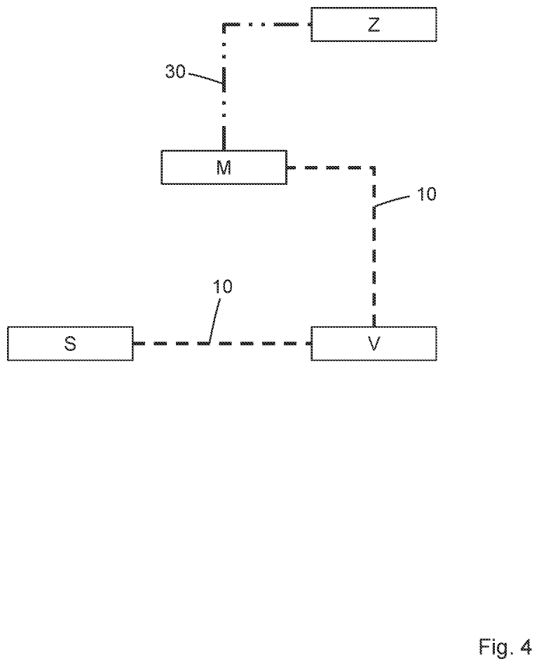

An alternative design is shown in FIG. 4. Here, along with the utility meter V and the autonomous sensor S, the assembly further comprises an autonomous module M. The autonomous sensor S communicates with the utility meter V via local communication paths 10. However, the utility meter V does not communicate directly with the central entity Z. The utility meter V continues to collect the sensor data from the autonomous sensor S. An autonomous module M is connected to the utility meter V via a local BLE/THREAD communication interface. Along with an interface for local communication paths 10, the autonomous module M also has a tertiary communication interface for the transmission via tertiary communication paths 30. LoRa, Sigfox, Silver Spring or a different LPWAN communication protocol, for example, can be used as a tertiary interface. The sensor data are collected by the utility meter V from the autonomous sensor S as in the design shown in FIG. 3. However, the sensor data and the consumption data are not transmitted directly from the utility meter V to the central entity Z, but to the autonomous module M. The data are therefore not transmitted directly from the utility meter V to the network operator or the energy supplier. The autonomous module M performs the task of then transmitting the data received from the utility meter V via a tertiary interface, such as e.g. LoRa, Sigfox or Silver Spring, to the network operator or energy supplier.

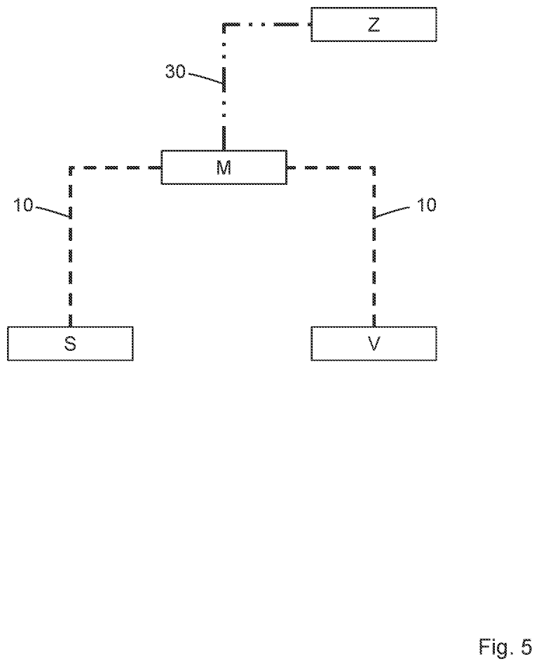

A further alternative design is shown in FIG. 5. Here, the assembly comprises a utility meter V, an autonomous sensor S and an autonomous module M. The components of the assembly in this design are the same as those in the design shown in FIG. 4. In the present design, however, the sensor data are collected by the autonomous module M. The sensor data from the autonomous sensors S are transmitted for this purpose via local communication paths 10 to the autonomous module M. The consumption data or the meter reading of the utility meter V are similarly transmitted via local communication paths 10 to the autonomous module M. The autonomous module M can retrieve the meter reading or the consumption data from the utility meter V. As in the design shown in FIG. 4, the autonomous module M then transmits the data consisting of sensor data and consumption data to the central entity Z. The transmission to the central entity Z is performed via a tertiary interface such as e.g. LoRa, Sigfox, Silver Spring or a different LPWAN communication protocol.

The following is a summary list of reference symbols and numerals, and the corresponding structure used in the above description of the invention:
V Utility meter
S Autonomous sensor
M Autonomous module
Z Central entity
KV Communication device of the utility meter
KS Communication device of the autonomous sensor
KM Communication device of the autonomous module
K Communication device of the central entity
W Measured value generator of the utility meter
E Sensor unit of the autonomous sensor
1 Antenna
10 Local communication
30 Tertiary communication
100 Pipeline

1. An assembly, comprising:
at least one utility meter for recording a flow rate, said at least one utility meter having:
a measured value generator,
a computing unit, and
a communication device; and
at least one autonomous sensor for recording measured quantities other than the flow rate, said at least one sensor having:
a sensor unit,
a computing unit, and
a communication device;
said at least one utility meter having an interface for radiocommunication with said autonomous sensor, and
said at least one utility meter having an interface for transmitting data received from said at least one autonomous sensor.

2. The assembly according to claim 1, further comprising an autonomous module with a housing and a communication device.

3. The assembly according to claim 2, wherein said autonomous module is a data collector.

4. The assembly according to claim 1, wherein each of said utility meter and/or said autonomous sensor has a separate housing.

5. The assembly according to claim 2, wherein said autonomous sensor is configured to transmit data to said utility meter and/or to said autonomous module.

6. The assembly according to claim 5, wherein said autonomous sensor is configured to transmit sensor data.

7. The assembly according to claim 1, wherein said communication device of said utility meter and/or said communication device of said autonomous sensor and/or said communication device of said autonomous module has a local communication interface which is configured to communicate via local communication paths.

8. The assembly according to claim 7, wherein the local communication paths are based on an Internet of Things (IoT) communication standard.

9. The assembly according to claim 7, wherein the local communication paths are based on the IEEE 802.15.4 communication standard.

10. The assembly according to claim 7, wherein the local communication paths are based on the Bluetooth Low Energy communication standard.

11. The assembly according to claim 1, wherein said communication device of said utility meter and/or said communication device of said autonomous module have a tertiary communication interface which is configured to communicate via tertiary communication paths with a central entity.

12. The assembly according to claim 11, wherein said utility meter and/or said autonomous sensor and/or said autonomous module communicate via local communication paths, and wherein the tertiary communication paths have a longer radiocommunication range than the local communication paths.

13. The assembly according to claim 1, wherein said at least one autonomous sensor is one of a plurality of autonomous sensors, and each autonomous sensor has an individual identifier so that each autonomous sensor is individually addressable.

14. A utility meter for recording flow rate, said utility meter being configured to form a part of the assembly according to claim 1.

15. A method for operating an assembly, the method comprising:
providing an assembly according to claim 1 with at least one utility meter, and at least one autonomous sensor;
using the utility meter and/or an autonomous module to communicate with the autonomous sensor; and
forwarding data received from the autonomous sensor from the utility meter and/or the autonomous module.

16. The method according to claim 15, which comprises forwarding the data received from the autonomous sensor from the utility meter to a central entity and/or to an autonomous module.

17. The method according to claim 15, which comprises transmitting the sensor data bundled with the consumption data.
